(19) United States
(12) Patent Application Publication
(10) Pub. No.: US 2016/0276646 A1
(43) Pub. Date: Sep. 22, 2016

(54) Vehicle Battery Grease Fitting Device

(71) Applicant: Carl Hutchins, Blufton, SC (US)

(72) Inventor: Carl Hutchins, Blufton, SC (US)

(21) Appl. No.: 14/664,080

(22) Filed: Mar. 20, 2015

(51) Int. Cl. H01M 2/30; H01R 11/28

(52) U.S. Cl. CPC H01M 2/302; H01R 11/284; H01M 2/305; H01M 2220/20

(57) ABSTRACT

A vehicle battery grease fitting device inhibits corrosion on battery terminals of a vehicle battery. The device includes a vehicle battery has a terminal post. A conduit extends through the terminal post. A terminal grease fitting is coupled to the terminal post. The terminal grease fitting is in fluid communication with the conduit wherein the terminal grease fitting is configured for dispersing grease through the terminal grease fitting into the conduit of the terminal post.

### BACKGROUND OF THE DISCLOSURE

### Field of the Disclosure

The disclosure relates to vehicle battery devices and more particularly pertains to a new vehicle battery device for inhibiting corrosion on battery terminals of a vehicle battery.

### SUMMARY OF THE DISCLOSURE

An embodiment of the disclosure meets the needs presented above by generally comprising a vehicle battery has a terminal post. A conduit extends through the terminal post. A terminal grease fitting is coupled to the terminal post. The terminal grease fitting is in fluid communication with the conduit wherein the terminal grease fitting is configured for dispersing grease through the terminal grease fitting into the conduit of the terminal post.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a vehicle battery grease fitting device according to an embodiment of the disclosure.

FIG. 2 is a cross-sectional view of a battery terminal post of an embodiment of the disclosure.

FIG. 3 is a top front side perspective view of a cable clamp of an embodiment of the disclosure.

FIG. 4 is a top view of a cable clamp of an embodiment of the disclosure.

FIG. 5 is a partial cutaway view of a cable clamp of an embodiment of the disclosure.

### DESCRIPTION OF THE PREFERRED EMBODIMENT

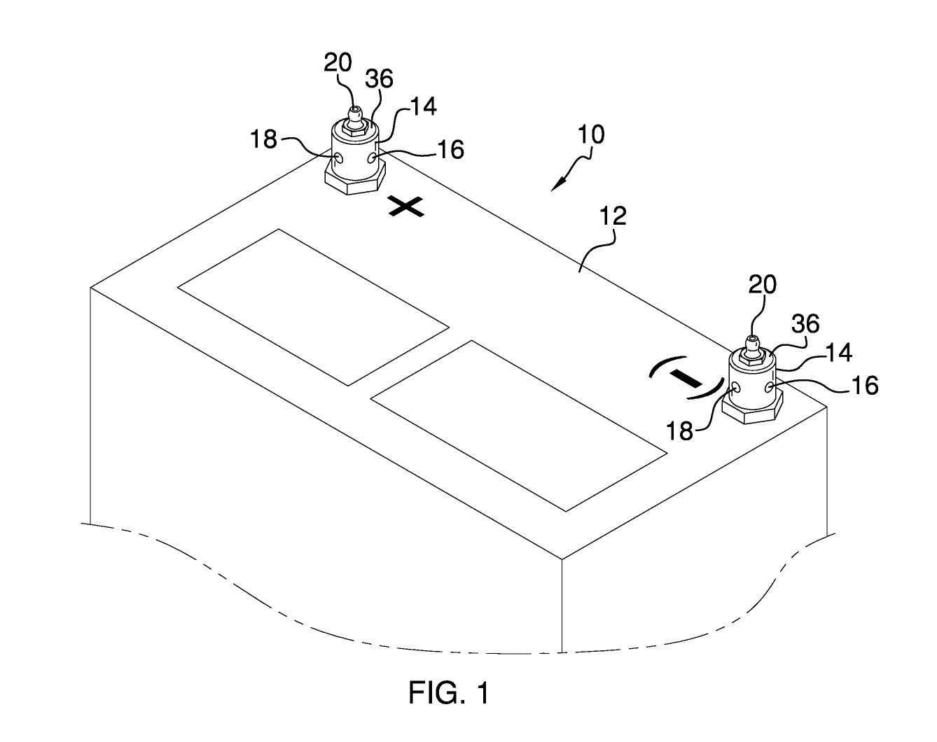

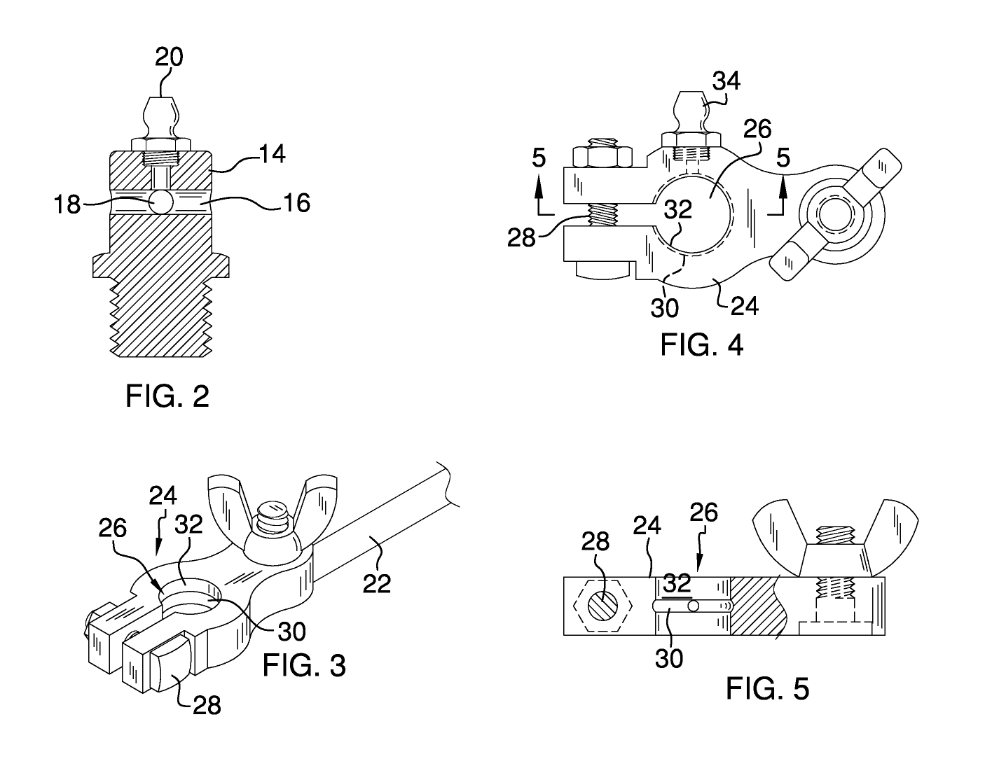

With reference now to the drawings, and in particular to FIGS. 1 through 5 thereof, a new vehicle battery device embodying the principles and concepts of an embodiment of the disclosure and generally designated by the reference numeral 10 will be described.

As best illustrated in FIGS. 1 through 5, the vehicle battery grease fitting device 10 generally comprises a vehicle battery 12 having a terminal post 14. The terminal post 14 has a conduit 16 extending through the terminal post 14. The conduit 16 through the terminal post 14 is oriented transverse to a longitudinal axis of the terminal post 14. The conduit 16 is one of a pair of conduits 16,18 extending through the terminal post 14. The pair of conduits 16,18 is coplanar and the conduits 16,18 are transversely oriented relative to each other. A terminal grease fitting 20 is coupled to the terminal post 14. The terminal grease fitting 20 is in fluid communication with the conduits 16,18 wherein the terminal grease fitting 20 is configured for dispersing grease through the terminal grease fitting 20 into the conduits 16,18 of the terminal post 14. The terminal grease fitting 20 extends from an upper surface 36 of the terminal post 14 and is aligned with the longitudinal axis of the terminal post 14.

A cable 22 of conventional manner is provided for electrically coupling the vehicle battery 12 to an electrical system of a vehicle. A cable clamp 24 is coupled to the cable 22. The cable clamp 24 is engageable to the terminal post 14 wherein the cable 22 is electrically coupled to the terminal post 14. The cable clamp 24 is structured to have a post hole 26 extending through the cable clamp 24. The post hole 26 is complementary to the terminal post 14 and the cable clamp 24 is tightened onto the terminal post 14 using a bolt 28 in a conventional manner. A groove 30 extends into a surface 32 of the cable clamp 24 defining the post hole 26. The groove 30 is positioned to align with the conduits 16,18 extending through the terminal post 14 when the terminal post 14 is fully inserted into the cable clamp 24. A clamp grease fitting 34 is coupled to the cable clamp 24. The clamp grease fitting 34 is in fluid communication with the groove 30. The clamp grease fitting 34 extends laterally outward from the cable clamp 24.

In use, the cable clamp 24 is used in a conventional manner to electrically couple the cable 22 to the terminal post 14. The terminal grease fitting 20 is used to inject grease for lubricating the terminal post 14 and cable clamp 24 to prevent corrosion and reduce the need to remove the cable clamp 24 from the terminal post 14 to periodically clean and maintain the connection between the cable 22 and the battery 12. In use, the above described structure is applicable to each of a positive terminal post and a negative terminal post.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle battery grease fitting device comprising:
a vehicle battery having a terminal post, said terminal post having a conduit extending through said terminal post; and
a terminal grease fitting, said terminal grease fitting being coupled to said terminal post, said terminal grease fitting being in fluid communication with said conduit wherein said terminal grease fitting is configured for dispersing grease through said terminal grease fitting into said conduit of said terminal post.

2. The device of claim 1, further comprising said conduit through said terminal post being oriented transverse to a longitudinal axis of said terminal post.

3. The device of claim 1, further comprising said conduit being one of a pair of conduits extending through said terminal post.

4. The device of claim 3, further comprising said pair of conduits being coplanar.

5. The device of claim 4, further comprising said conduits being transversely oriented relative to each other.

6. The device of claim 1, further comprising:
a cable; and
a cable clamp coupled to said cable, said cable clamp being engageable to said terminal post wherein said cable is electrically coupled to said terminal post, said cable clamp being structured to have a post hole extending through said cable clamp, said post hole being complementary to said terminal post.

7. The device of claim 6, further comprising a groove extending into a surface of said cable clamp defining said post hole, said groove being positioned to align with said conduit extending through said terminal post when said terminal post is fully inserted into said cable clamp.

8. The device of claim 7, further comprising a clamp grease fitting coupled to said cable clamp, said clamp grease fitting being in fluid communication with said groove.

9. A vehicle battery grease fitting device comprising:
a vehicle battery having a terminal post, said terminal post having a conduit extending through said terminal post, said conduit through said terminal post being oriented transverse to a longitudinal axis of said terminal post, said conduit being one of a pair of conduits extending through said terminal post, said pair of conduits being coplanar, said conduits being transversely oriented relative to each other;
a terminal grease fitting, said terminal grease fitting being coupled to said terminal post, said terminal grease fitting being in fluid communication with said conduit wherein said terminal grease fitting is configured for dispersing grease through said terminal grease fitting into said conduit of said terminal post;
a cable;
a cable clamp coupled to said cable, said cable clamp being engageable to said terminal post wherein said cable is electrically coupled to said terminal post, said cable clamp being structured to have a post hole extending through said cable clamp, said post hole being complementary to said terminal post;
a groove extending into a surface of said cable clamp defining said post hole, said groove being positioned to align with said conduit extending through said terminal post when said terminal post is fully inserted into said cable clamp; and
a clamp grease fitting coupled to said cable clamp, said clamp grease fitting being in fluid communication with said groove.
